(19) United States
(12) Patent Application Publication
(10) Pub. No.: US 2008/0204885 A1
(43) Pub. Date: Aug. 28, 2008

(54) Methods for Producing a Structured Sol-Gel Layer

(76) Inventors: Michael Ukelis, Riedstadt (DE); Monika Kursawe, Seeheim-Jugenheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/065,122

(22) PCT Filed: Aug. 4, 2006
(86) PCT No.: PCT/EP2006/007709

§ 371 Date: Feb. 28, 2008

(30) Foreign Application Priority Data
Aug. 31, 2005 (DE) 102005041243.2

(51) Int. Cl. G02B 5/02; B05D 5/06

(52) U.S. Cl. 359/599; 427/162

(57) ABSTRACT

The present invention relates to processes for the production of a structured surface on a substrate in which a substrate is introduced into a sol which has been set in vibration or a substrate which has been set in vibration is introduced into a sol which has optionally been set in vibration. The present invention likewise relates to substrates structured in this way and to the use thereof in optical applications.

The present invention relates to a process for the production of a structured surface on a substrate in which a substrate is introduced, in particular dipped, into a sol which has been set in vibration or a substrate which has been set in vibration is introduced, in particular dipped, into a sol which has optionally been set in vibration. The present invention likewise relates to substrates structured in this way and to the use thereof in optical applications.

Structured surfaces play a role in a number of applications and processes. Surface-structured substrates are also increasingly achieving importance in optical applications, for example as diffusers or as reflectors. Optical diffusers are scattering areas at which incident light is scattered in a diffuse manner. Common examples of the use of optical diffusers are, for example, matt screens in photography or projection technology, onto which an image is projected. The light which hits the matt screen for image production is scattered thereby, i.e. deflected in various directions. This scattering results in the image projected onto the matt screen being visible from various directions. Diffusers are also increasingly being used in liquid-crystal displays (LCDs), for example for the production of flat illumination. There is therefore a demand for processes by means of which surfaces which scatter in a diffuse manner can be provided.

The object was therefore to provide processes for the structuring of a substrate surface which are easy to carry out and which enable the provision of structured surfaces for a wide range of applications.

Processes of the present invention satisfy the complex requirement profile in a surprising manner. The present invention accordingly relates to processes for the production of a structured surface on a substrate in which a substrate is introduced, in particular dipped, into a sol which has been set in vibration or a substrate which has been set in vibration is introduced, in particular dipped, into a sol which has optionally been set in vibration.

For the purposes of the present invention, a structured surface is a surface which has a regular or irregular structure, in particular in the form of grooves, indentations or bumps of any type. The indentations and bumps can adopt any desired shape here and are in the nanometre to millimetre size range.

The process according to the invention has the advantage that it is simple to carry out and offers the possibility of producing a wide variety of types of structuring. In a simple step, the structure is preserved directly in a stable coating and does not require additional stabilisation. In this way, structures can be produced on the surface of a substrate in a one-step process. In addition, refractive-index adaptation in order to control the optical effects can be achieved by suitable mixing of corresponding sols, for example of TiO₂ and SiO₂ sols.

In a specific embodiment, the processes according to the invention are suitable for the production of diffusers for liquid-crystal displays. In general, backlighting, which ensures adequate contrast, is employed for LCDs. In particular in the case of battery-supported LCDs, for example in notebooks, the associated energy consumption is evident in a negative way since the running time of the battery is additionally limited. For this reason, there is interest in the development of LCDs which do not need backlighting. This requires the use of reflectors, which should satisfy at least the following requirements:
incident light should be distributed uniformly over the entire area of the display in the viewing-angle range of the viewer
outside the viewing-angle range, as little reflection as possible should occur
the structuring should prevent interference phenomena.

With the process in accordance with the present invention, the provision of surfaces structured in this way is conceivable.

Suitable substrates in the present invention are glass substrates, ceramic substrates, metal substrates or plastic substrates, preferably glass, metal or ceramic substrates and very particularly preferably glass substrates or metal substrates. Glass substrates or metal substrates having structured surfaces are particularly suitable for optical applications, in particular for LCDs.

Suitable materials for glass substrates are all known glasses, for example float glass, cast glass of all glass compositions known to the person skilled in the art, A, C, D, E, ECR, R or S glasses.

Suitable metal substrates are, for example, polished or bright-drawn metal sheeting having an average roughness value of <1 μm. Suitable plastic substrates consist, for example, of PMMA or polycarbonate. Suitable ceramic substrates are all ceramics known to the person skilled in the art, in particular transparent ceramics, which can be structured using one of the methods mentioned below.

The sols which are suitable in the process according to the invention can be all sols known to the person skilled in the art, for example sols of compounds of the elements titanium, zirconium, silicon, aluminium and/or mixtures thereof. Preference is given to the use of silicon sols. Sols or precursors of this type are known and commercially available. The silicon sols are usually those in which the SiO₂ particles have been obtained by hydrolytic polycondensation of tetraalkoxysilane, in particular tetraethoxysilane (TEOS), in an aqueous/alcoholic/ammoniacal medium. It is of course also possible to employ aqueous and/or solvent-containing sols prepared in a different way as coating solution.

In addition, the coating solution may additionally comprise surfactants. Furthermore, the coating solutions that can be employed for the sol-gel process may comprise further components, such as, for example, flow-control agents or complexing agents.

The respective solids content in the coating solution is usually in the range from 0.1 to 20% by weight, preferably from 2 to 10% by weight.

Coating solutions of the above-mentioned types are described, for example, in DE 198 28 231, U.S. Pat. No. 4,775,520, U.S. Pat. No. 5,378,400, DE 196 42 419, EP 1 199 288 or WO 03/027015, the disclosure contents of which are hereby incorporated into the present invention by way of reference.

The coating of the substrate is preferably carried out by dip coating, where the sol or substrate or optionally both are set in vibration. In this way, the substrate is coated with the sol, with the applied layer having a structuring caused by the vibrations of the sol and/or substrate. Preferably, only the sol is set in vibration.

For the purposes of the present invention, the vibrations can be generated either by mechanical or by electromechanical vibration generators. Mechanical vibration generators generally consist of a motor-driven rotating un-balanced mass, where the imbalance is in the simplest case transferred mechanically to the container containing the sol, for example a cell, and/or the substrate. The mechanical vibration generator can be driven electrically, pneumatically, hydraulically or by means of an internal-combustion engine, depending on the desired application. In the preferred embodiment, the substrate is dipped into a sol-filled cell by means of a lifting device, where the cell and thus the sol or the sol alone is set in vibration. The substrate is subsequently withdrawn from the cell at a uniform speed. If the substrate is dipped into the vibrating sol and withdrawn again, a non-uniform coating of the substrate with the coating solution occurs. In this way, a structured surface is produced, with the type and degree of structuring being crucially dependent on the vibration frequency set and the sols and apparatuses employed. The structuring obtained can be matched to the needs by expert adaptation of the above-mentioned parameters. Since the structuring takes place directly on the surface of the substrate by coating in a sol set in vibration, the structures have “soft” transitions without edges and corners. The structuring period can likewise be controlled via the frequency of the vibration employed and thus also matched to the needs.

Electromechanical vibration generators generally consist of an electromagnet system or piezo system which is stimulated to vibrate by high-frequency alternating voltage. These vibrations are distinguished by a very broad possible frequency spectrum. The individual types and variants of vibration generators and the physical design thereof are familiar to the person skilled in the art and can be adapted to the respective needs in a simple manner. Thus, on use of ultrasound it can be, for example, a corresponding ultrasound bath into which the sol-containing container is introduced. The vibrations are transmitted to the sol in the container. Alternatively, it is conceivable to use an ultrasound transmitter directly in the sol employed, for example in the form of a sonotrode, which is dipped into the sol.

Typical frequency ranges for the vibrations which are employed for vibration excitation of the sol are from 5 Hz to 50 kHz, preferably from 5 to 500 Hz.

The thickness of the applied layer depends essentially on the drawing speed of the substrate during the coating. The greater the drawing speed, the thicker the layer obtained. The drawing speeds are usually in the range from 0.01 to 250 mm/sec and preferably in the range from 1 to 20 mm/sec and very particularly preferably in the range from 2 to 10 mm/sec. The coating operation can of course also be repeated one or more times until the desired thickness has been achieved. The individual parameters are preferably matched to one another in such a way that the structured surface satisfies the desired conditions.

For compaction and solidification of the applied structured layer, the structured substrate can be calcined. The calcination removes the residual solvent contents from the applied layer. The calcination temperatures are usually from 300 to 700° C., in particular from 500 to 600° C.

In a further embodiment of the present invention, the structured surface is additionally coated with a metal layer. This additional step follows the coating by the sol-gel process and can be carried out subsequently at any time. The coating with a metal layer can be carried out by wet-chemical methods, for example by suitable reduction processes, by the CVD process and/or PVD process, the PVD process being preferred.

Suitable as metal for the additional metal layer are, for example, aluminium, silver, chromium, nickel or other reflective metal layers. The metal layer is preferably aluminium.

The thickness of the additional metal layer depends on the material and the desired properties and is usually in the range from 10 to 150 nm and in particular in the range from 30 to 100 nm.

The present invention likewise relates to substrates having a structured surface, produced by one of the processes according to the invention.

The present invention furthermore relates to the use of substrates having a structured surface which are obtainable by the processes described above, as diffusers and/or reflectors in optical applications. The optical applications can be all optical applications known to the person skilled in the art, for example cameras of any design, projectors and projection screens, liquid-crystal displays, magnification systems, for example microscopes, etc. The substrates according to the invention are preferably used in liquid-crystal displays, where the structured substrates in accordance with the present invention can be employed particularly advantageously, for example as reflective background in order to replace backlighting and thus to enable a reduction in the energy consumption of the display. Further areas of application of the structured substrates in accordance with the present invention are evident to the person skilled in the art without an inventive step.

The following examples are intended to explain the present invention in greater detail, but without limiting it.

### EXAMPLES

### Example 1

A CrNi steel cell measuring 250×30×350 mm is filled with an aqueous/alcoholic SiO₂ sol (solids content: 3% by weight).

A mechanical vibration generator is mounted centrally on the upper lip of the cell. The vibration generator is a commercially available electrical motor with imbalance weight (mass of the imbalance weight about 10 g), which is attached to the cell via a clamping device. A float-glass sheet approximately 1 mm thick is mounted on a lifting device and dipped into the cell. After the vibration generator has been switched on (frequency: 120 Hz), the glass sheet is drawn out of the cell at a speed of 5 mm/sec by means of the lifting device. The glass sheet is dried for 10 minutes at room temperature. A coated float-glass sheet is obtained, where the coating has a surface structuring which scatters in a diffuse manner.

1. Process for the production of a structured surface on a substrate, characterised in that a substrate is introduced into a sol which has been set in vibration or a substrate which has been set in vibration is introduced into a sol which has optionally been set in vibration.

2. Process according to claim 1, characterised in that the substrate is dipped into a sol which has been set in vibration or a substrate which has been set in vibration is dipped into a sol which has optionally been set in vibration.

3. Process according to claim 1, characterised in that the sol is a sol of compounds of the elements titanium, zirconium, aluminium, silicon and/or mixtures thereof.

4. Process according to claim 1, characterised in that the vibration is generated by mechanical or electromechanical vibration generators.

5. Process according to claim 1, characterised in that the structured surface is additionally coated with a metal layer.

6. Process according to claim 5, characterised in that the coating with a metal layer is carried out by wet-chemical methods, by the CVD process and/or PVD process.

7. Process according to claim 5, characterised in that the metal is aluminium, silver, chromium, nickel or other reflective metal layers.

8. Substrates having a structured surface, produced by one or more of processes 1 to 7.

9. Substrates according to claim 8, characterised in that the substrate is a glass substrate, ceramic substrate, metal substrate or plastic substrate.

10. Use of substrates having a structured surface, produced by one or more of processes 1 to 7, as diffusers and/or reflectors in optical applications.

11. Use according to claim 10, characterised in that the optical applications are liquid-crystal displays.
